(19) United States
(12) Patent Application Publication
(10) Pub. No.: US 2009/0231865 A1
(43) Pub. Date: Sep. 17, 2009

(54) Compact fluorescent bulb installation, replacement and storage containment device

(76) Inventors: Larry Lee Ludtke, JR., Woodbridge, MI (US); Patricia Ann Ludtke, Woodbridge, VA (US)

Correspondence Address: JUST IN TIME PRODUCTS, LLC, 261 WOODBRIDGE, SALINE, MI, 48176, US

(21) Appl. No.: 12/151,408

(22) Filed: May 7, 2008

Related U.S. Application Data
(60) Provisional application No. 61/035,718, filed on Mar. 11, 2008.

(51) Int. Cl. F21V 25/02

(52) U.S. Cl. 362/457

(57) ABSTRACT

The bulb bag includes a Velcro™ strap, a foam rubber seal, a rubber pouch and a tensioning clip (optional). A fluorescent bulb removal, installation and storage device to contain glass shards and mercury in case of breakage during bulb installation, replacement and storage. The device is placed over the bulb and sealed by a foam and Velcro™ seal at the base of the bulb. This device will contain any glass shards and mercury from escaping in case of accidental breakage during bulb installation, replacement and storage.

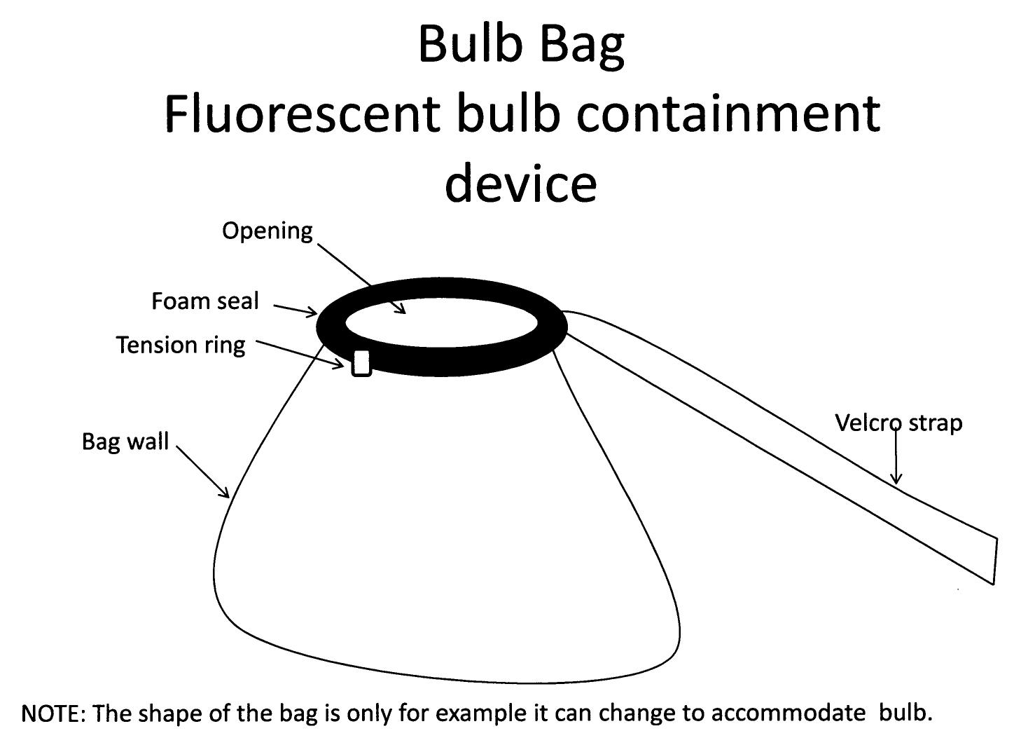

### CROSS REFERENCE TO RELATED APPLICATION

This application claims the benefit of our earlier filed provisional application No. 61/035,718

### BRIEF DESCRIPTION

This invention is a containment device for compact fluorescent bulbs of many different styles, shapes and wattages. It is a flexible bag-type device that will easily conform to the shape of the bulb or the bag can be sized to fit the bulb for a specific consumer requirement. It will be secured at the base of the bulb by a Velcro™ strap. Ideally, this device will be made of non-porous latex or latex-free rubber material and Velcro™ strap material. However, other suitable material can be used as the system develops. The wall thickness will be substantial enough not to be punctured if breakage occurs during reasonable handling and use. The seal is ideally made of foam rubber or similar products and seals around the base of the bulb either by friction or the tightening of the Velcro™ strap to create a positive seal. This device is reusable if the bulb remains intact during installation, removal and storage. If the bulb breaks during removal, installation or storage, is bag is not reusable. If breakage occurs the bag is to remain sealed around the base of the bulb and disposed of in compliance with federal, state and local regulations pertaining to hazardous mercury disposal. This device is not intended for use during the operation. This device can have a tension ring or can be produced without the tension ring.

### BRIEF DESCRIPTION OF THE DRAWINGS

The invention will be better understood and objects other than those set forth above will become apparent when consideration is given to the following detailed description thereof. Such description makes reference to the annexed drawings wherein: is a perspective view of a first embodiment of Compact Fluorescent Bulb Installation, replacement and storage containment device comprising the present invention.

No mew matter is entered in this specification this references the drawing which was not referenced in the original specification

What is claimed is:

1. A fluorescent bulb containment device, said fluorescent bulb containing hazardous material comprising: A device having side walls and bottom surface defining an interior area; a top seal comprised of a Velcro™ strap and foam rubber seal. This device positions over the bulb and is secured to the porcelain base of said bulb. This device is a latex rubber or vinyl plastic bag-type device at least 20-30 mil in thickness. It has a Velcro™ band around the outside of the open end and a dense foam rubber seal on the inside of the open end. Upon accidental breakage this device will contain any glass shards and mercury.
